(19) United States
(12) Patent Application Publication
(10) Pub. No.: US 2012/0222292 A1
(43) Pub. Date: Sep. 6, 2012

(54) CONDUCTOR HANDLING TOOL AND A METHOD OF APPLYING AN ELECTRICALLY INSULATING MATERIAL

(75) Inventors: Rudi Velthuis, Lauchringen (DE); Marco Schneider, Baden (CH); Nikolaus Zant, Zurich (CH); Riccardo Fiasco, Lenzburg (CH); Benjamin Weber, Winterberg (DE)

(73) Assignee: ABB RESEARCH LTD, Zurich (CH)

(21) Appl. No.: 13/344,225

(22) Filed: Jan. 5, 2012

Related U.S. Application Data
(63) Continuation of application No. PCT/EP2010/059882, filed on Jul. 9, 2010.

(30) Foreign Application Priority Data
Jul. 15, 2009 (EP) 09165562.1

(51) Int. Cl. H01F 41/12; B26B 27/00; H01F 41/06

(52) U.S. Cl. 29/605; 30/296.1

(57) ABSTRACT

A conductor handling tool has a plate-shaped tool body. The tool body includes a conductor receiving opening for receiving a conductor portion therein and for holding the conductor portion received therein. Further, an edge of the plate-shaped tool body is shaped convex as a tapered blade edge extending substantially within a y-z-plane. The tapered blade edge is directed away from the conductor receiving opening and is forming an outer circumferential portion of the tool body for splitting a portion of insulating material during winding of the insulating material.

This application claims priority as a continuation application under 35 U.S.C. §120 to PCT/EP2010/059882, which was filed as an International Application on Jul. 9, 2010 designating the U.S., and which claims priority to European Application 09165562.1 filed in Europe on Jul. 15, 2009. The entire contents of these applications are hereby incorporated by reference in their entireties.

### FIELD

The disclosure relates to insulating material, such as methods of applying an electrically insulating material onto at least a portion of an electrical device such as an electric coil, and to a conductor handling tool.

### BACKGROUND INFORMATION

Known electrical devices should be insulated in such a way that only a few defined connectors are accessible from the outside. For example, transform coils should be insulated, and they also should have a number of connectors that allow connecting specific positions within the coil from the outside.

Suitable insulation materials for insulating electrical devices can be e.g. a composite made of glass fibers and resin. The insulation material can be wound onto the coil by rotating the coil. The connectors are provided by ends or intermediate portions of the wire. The connectors need to go through the insulation material. This can be achieved by manually guiding these wire ends or intermediate portions through the impregnated glass fibers during winding of the insulation material, i.e. during rotation the coil.

One known technique of applying the insulating composite material is wet filament winding, during which the resin is still liquid. The glass fibers and hence the insulating layer may be penetrated by a portion of the copper wire. This copper wire portion is then connected to a copper connection plate which is called flag. This technique specifies a sufficiently stable and therefore thick wire, otherwise the wire is unable to penetrate the glass fibers.

Another known technique is dry filament winding. Here, e.g. a B-staged prepreg is used as the insulating material. During the dry winding there is no space between the fibers bundles and the resin is solid. Therefore, in this case even wires of intermediate thickness are unable to spread the glass fibers.

With this method, if the wire is too thin or if the insulating material is too dense during application, the wire is unable to spread the glass fibers reliably. FIG. 6 illustrates a difficulty which may arise in a previous method of applying an insulating material in accordance with an exemplary embodiment. As shown in FIG. 6, the wire may be bent and buried by the glass fiber bundle. Herein, instead of penetrating through the insulating material 7, the wire 3 is pressed by the applied insulating material to one side and is subsequently covered with further insulation material 7.

In DE 3836139 a T-shaped handling tool is disclosed for the purpose of continuous winding a conductor onto a coil body. The tool is placed onto a coil body and one end of the conductor is fixed to the coil body before winding the conductor wire. A wing of the tool which has a curved and tapered blade is used to direct the wire on the respective side of the wing in order to allow the continuous winding. After conductor winding the handling tool has to be removed by breaking of the wing.

U.S. Pat. No. 3,979,615 discloses a conductor clamping tool consisting of an iron sheet which is bent square like for clamping ends of a coil winding of a motor to lead-in wires of a connector. One end of the iron sheet having a V-shaped wire receiving slot with tapered blade edges in between the inserted lead wire is clamped. In this way the end of the coil winding is electrically connectable to the lead-in wire.

Therefore, there is a need for a more reliable way of applying the electrically insulating material onto the electrical device.

### SUMMARY

An exemplary method of producing an electrical coil is disclosed, the electrical coil having a conductor portion, comprising the steps of: winding a wire to a raw coil; providing at least one conductor portion protruding from the raw coil, the at least one conductor portion being an electrical connector; inserting the electrical connector into a conductor receiving section of a conductor handling tool having a curved plate-shaped tool body such that a tapered blade edge of the tool body is directed away from the conductor portion; winding a tape of an electrically insulating material onto at least a portion of the raw coil; splitting a tape portion of the tape by the blade edge; and removing the conductor handling tool from the conductor portion after splitting.

An exemplary conductor handling tool is disclosed comprising: a curved plate-shaped tool body, the tool body including: a conductor receiving opening for receiving a conductor portion and for holding the conductor portion received, wherein an edge of the plate-shaped tool body is shaped as a tapered blade edge extending substantially within a y-z-plane, and directed away from the conductor receiving opening, and wherein the tapered blade edge forms an convex outer circumferential portion of the tool body for splitting a portion of insulating material during a winding of the insulating material.

An exemplary method of producing a transformer, comprising: producing a first electrical coil by winding a first wire to a first raw coil, providing at least one first conductor portion protruding from the first raw coil, wherein the at least one first conductor portion is a first electrical connector, inserting the first electrical connector into a conductor receiving section of a first conductor handling tool having a curved plate-shaped tool body such that a first tapered blade edge of a first tool body is directed away from the first conductor portion, winding a first tape of a first electrically insulating material onto at least a portion of the first raw coil, splitting a portion of the first tape by the first blade edge, and removing the first conductor handling tool from the first conductor portion after splitting; producing a second electrical coil by winding a second wire to a second raw coil, providing at least one second conductor portion protruding from the second raw coil, wherein the at least one second conductor portion is a second electrical connector, inserting the second electrical connector into a conductor receiving section of a second conductor handling tool having a curved plate-shaped tool body such that a second tapered blade edge of a second tool body is directed away from the second conductor portion, winding a second tape of a second electrically insulating material onto at least a portion of the second raw coil, splitting a portion of the second tape by the second blade edge, and removing the second conductor handling tool from the second conductor portion after splitting; providing a transformer housing; and placing the first electrical coil and the second electrical coil in the transformer housing so that the first electrical coil and the second electrical coil are inductively coupled.

### BRIEF DESCRIPTION OF THE DRAWINGS

Further aspects of the disclosure will be better understood by reference to the Figures, in which

FIGS. 1a to 1c show a first conductor handling tool in respective side views from the y, x, and z direction, respectively in accordance with an exemplary embodiment;

FIGS. 2a to 2c show steps of applying insulating material to an electrical device in accordance with an exemplary embodiment;

FIGS. 3a to 3c show a second conductor handling tool in respective side views from the y, x, and z direction, respectively in accordance with an exemplary embodiment;

FIGS. 4a and 4b show a third conductor handling tool in a cross-sectional side view from the y direction in accordance with an exemplary embodiment;

FIG. 5 show a detail of a conductor receiving opening in a cross-sectional side view from the y direction in accordance with an exemplary embodiment; and

FIG. 6 illustrates a difficulty which may arise in a method of applying an insulating material in accordance with a known technique.

### DETAILED DESCRIPTION

According to a first exemplary embodiment of the disclosure, the conductor handling tool has a curved plate-shaped tool body. Here, plate-shaped means that the tool body defines a plane, so that the tool body's thickness in a direction orthogonal to the plane is smaller than the (maximal) extension of the tool body in any direction within the plane. The tool body includes a conductor receiving opening for receiving a conductor portion therein and for holding the conductor portion received therein. Further, an edge of the plate-shaped tool body is convex and shaped as a tapered blade edge extending substantially within a y-z-plane, i.e. these directions are defined by the plane in which the blade edge extends. Generally, the x-, y- and z-direction are mutually orthogonal. The tapered blade edge is directed away from the conductor receiving opening and forms an outer circumferential portion of the tool body for the purpose of splitting a portion of an insulating material which is applied during winding of the insulating material to an electrical coil. In embodiments, the conductor receiving opening is a wire receiving slit.

According to a second exemplary embodiment of the disclosure, a method of producing an electrical coil is provided, wherein the electrical coil includes a conductor portion protruding from the electrical device portion. The method including:
winding a wire to a raw coil;
providing at least one conductor portion which being an electrical connector;
inserting the electrical connector into a conductor receiving section of a conductor handling tool having a plate-shaped tool body such that a tapered blade edge of the conductor handling tool is directed away from the conductor portion;
winding a tape of an electrically insulating material onto at least a portion of the raw coil; and
splitting a tape portion of the tape by the blade edge.

In exemplary embodiments of the disclosure, the method further includes removing the conductor handling tool from the conductor portion after splitting the tape portion. In embodiments, the electrical device is an electric coil, and the electrically insulating material is applied by winding the electrically insulating material around the coil. The protruding conductor portion may be wire or a connection flag.

In other exemplary embodiments disclosed herein, the tape of electrically insulating material is a tape having unidirectional fibers, e.g. a prepreg tape. The tape can be wound with the fibers extending substantially in the direction of the blade edge so that the tape is split by the blade edge substantially along the direction of the fibers. In this case the spreading may be performed without cutting a substantial number of fibers, thus increasing the stability of the insulating layer.

During application of the insulating material, the conductor handling tool and the exemplary method described herein enhances the stability of the wire during application of the insulating layer and, in particular, may prevent wire ends to be deformed by the insulating material. This advantage is especially important for thin wires with a diameter up to approx. 6 mm, for example, or at least up to 4 mm, as the stability of these wires is especially low. In the present disclosure, a diameter shall refer to the largest cross-sectional extension in the cross-sectional plane perpendicular to the lengthwise wire extension. For example, for a wire having a quadratic cross-section, the diameter is the length of the diagonal. Likewise, the slit diameter is defined as the largest cross-sectional extension of the slit, wherein the slit is within an enveloping surface of the tool body. The tool and the method are also applicable to conductors and outside connections other than wires like e.g. aluminum or copper flags.

A further advantage is obtained by the blade edge, which allows reliable spreading of insulating material (e.g. prepreg tape) at a random tape position. Thereby, the displacement or bending of wire during its stacking through the prepreg is reduced.

Another advantage of the exemplary embodiments of the present disclosure is that due to the tapered blade edge, the amount of insulating material being deposited on top (outside end) of the conductor (e.g. the connection flag) is reduced. Without the conductor handling tool, some of the insulating material would stay on the top of the flag, due to the flag's top surface being flat and having a thickness of sometimes up to 6 mm, for example, or even more. In contrast, according to aspects of the disclosure, thanks to the sharp blade edge almost all of the insulating material can slide along the tool body instead of being deposited on top of the flag.

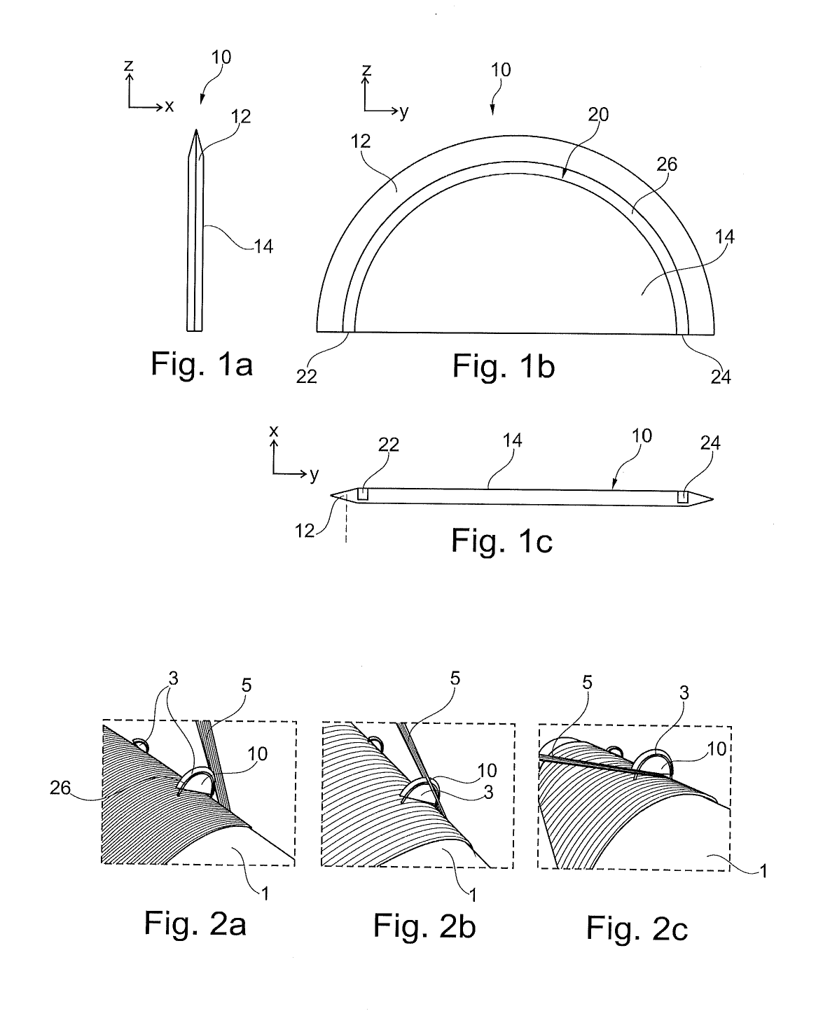

FIGS. 1a to 1c show a first conductor handling tool in respective side views from the y, x, and z direction, respectively in accordance with an exemplary embodiment. In FIGS. 1a to 1c, the conductor handling tool is shown in respective side views from the y direction (FIG. 1a), from the x direction (FIG. 1b), and from the z direction (FIG. 1c). Also, respective directions x, y and z are indicated in each of the Figures. These directions are orthogonal with respect to each other.

The conductor handling tool has a tool body 10, a conductor receiving opening 20 (formed as a slit 26 with two open ends 22, 24) and a tapered blade edge 12, which extends in a plane. The above directions x, y and z are defined such that the plane in which the blade edge 12 extends is the y-z plane.

### Tool Body 10

The tool body 10 is shaped as a plate, with its extension in one direction (the x direction) being smaller than its extension in the other directions (the y and z directions). The plate has a semi-circular shape. The tapered blade edge 12, to be described in more detail below, is arranged at the semi-circularly bent side of the tool body 10. Opposite to the blade edge 12, there is a base side of the tool body 10.

FIGS. 1a to 1c illustrate some general aspects relating to the tool body 10. The thickness (extension in the x direction) of the tool body 10 is determined by the diameter of the wire to be inserted, in addition to the material specified to hold the tapered blade edge. In exemplary embodiments of the present disclosure, the extension in the x direction can be less than half, for example, and more preferably less than, a third, a fifth, or even a tenth of the extension in any of the other orthogonal directions y and z. In another exemplary embodiment, the tool body 10 can have a cross section in a x-y plane. The cross-section, for example, having a y:x aspect ratio of at least 3:1, at least 5:1 or at least 10:1 Here, the y:x aspect ratio is defined as the maximum extension of the cross-section in the y direction divided by the maximum extension of the cross-section in the x direction.

Generally, the height of the tool body in z direction can be at least two times or five times the width of the conductor receiving opening 20. For example, a tool body with height in z direction of merely two times the width of the conductor receiving opening 20 could be constructed similarly to the tool body 10 shown in FIGS. 1a to 1c, but with the conductor receiving opening 20 being arranged close to the base so that the inner support portion 14 takes very little height, and also with an obtuse-angled blade edge 12 having a blade angle of more than 45°, thus taking very little height. In absolute numbers, the height of such an embodiment may be as little as 2 mm (for a conductor receiving opening 20 having a width of, say, 1 mm). For other embodiments (e.g. the embodiment shown in FIGS. 1a to 1c), the height may generally be at least 5 mm, for example, or at least 2 cm, or even at least 5 cm. Further, the height of the tool body in z direction is generally no more than 20 cm, or even no more than 10 cm.

The tool body 10 can be made of any material like plastic, metal, ceramics etc., and in particular may be made of an insulating material such as plastic. Further, the tool body 10 is rigid, such that it defines an substantially fixed spatial relation between the conductor receiving opening 20 and the blade edge 12. In some embodiments, the tool body has at least a surface that comprises a non-sticking material such as PTFE. Further, it is preferred that the tool body is integrally made of one piece.

### Conductor Receiving Opening 20

The conductor receiving opening 20 is shaped for receiving a conductor portion therein. In the embodiments of FIGS. 1a to 1c, the conductor receiving opening 20 is formed as a wire receiving slit for receiving the wire sideways therein, and for holding the wire portion received therein. The slit 26 extends within the y-z plane, or more precisely within a plane that is parallel to the y-z-plane (here, the term parallel plane may also refer to the y-z-plane, since the y-z-plane is parallel to itself). The slit 26 is open to one side, such that the wire can be inserted into the slit 26 from the side.

The wire receiving slit 26 has a first open end 22 and a second open end 24 for receiving an intermediate wire section in the slit 26 between these ends 22 and 24. These open ends are located at the base side of the tool body 10, opposite to the blade edge 12.

It is a general aspect that the conductor receiving opening 20 (here, the slit 26), should be dimensioned such that the maximum extension of the tool body 10 in the x direction is less than, for example, four times, or even less than twice, or even less than 1.5 times, the maximum wire diameter of a circular wire fitting in the conductor receiving opening 20 (as can be seen e.g. in FIG. 1c, the maximum wire diameter corresponding to the lateral dimension in x direction of the ends 22 and 24 of the conductor receiving opening). It is another general aspect that the conductor receiving opening 20 should be dimensioned such that the maximum extension of the tool body 10 in the x direction is less than four times the maximum extension of the conductor receiving opening 20 in the x direction.

In absolute values, the wire receiving slit 26 generally has a cross-sectional diameter (in a plane orthogonal to the slit extension) of more than 1 mm, for example. Further, the wire receiving slit generally has a cross-sectional diameter of less than 8 mm.

### Blade Edge 12

The tapered blade edge 12 extends within the y-z-plane (actually this defines the y-z plane) and is directed away from the conductor receiving opening 20. This means that in the y-z-plane, the blade edge cutting side is facing away from the projection of the conductor receiving opening 20 onto the y-z-plane (as seen in FIG. 1b).

The tapered blade edge has a blade angle which can be seen in FIG. 1a. Here, the blade angle is defined as the angle of the blade edge in a cross-sectional surface normal to the blade edge. The sharper the edge, the easier the spreading, if the blade edge is stable enough. Even an angle of 89° would be possible. Generally, the tapered blade edge has a blade angle of less than 30°, for example, or even less than 20°.

In a lateral cross-section of the tool body 10 parallel to the y-z plane, i.e. to the viewing plane of FIG. 1b, the tapered blade edge 12 forms an outer circumferential portion of the tool body 10 which is convex shaped (see FIG. 1b). Further, the conductor receiving opening 20 includes a slit 26 forming an intermediate portion of the tool body 10. Further, an inner flat support portion 14, with flat surfaces parallel to the y-z plane, forms an inner portion of the tool body 10. In FIG. 1b, all these portions have semicircular shape. However, they may alternatively have any other shape, e.g. any bent shape.

As a general aspect illustrated here, the blade edge is bent within the y-z plane. For example, in FIG. 1b, the blade edge is shown as a semicircle. In alternative embodiments, other circular segments or, still more generally, curved shapes are also possible.

It can be seen from FIG. 1b that both the blade edge and the slit 26 of the conductor receiving opening 20 have a semicircular shape. It is a general aspect that the blade edge runs along the slit 26 of the conductor receiving opening 20, irrespective of their shape.

### Base:

The tool body 10 has a base, formed at the side of the plate that is opposite to the blade edge 12. The base side is adapted to contact the electrical device portion during operation. Therefore, the open ends 22 and 24 of the conductor receiving opening 20 are located at the base side. As a more general aspect, the conductor receiving opening 20 extends to the base side of the tool body 10. Further, the open ends 22 and 24 end at the base side at an right angle. This allows for the wires portions to be inserted in the ends 22 and 24 in parallel to one another. Other positions, e.g. having a different angle, are also possible. The position depends on the equipment and on the conductor.

In the embodiment of FIG. 1b, the base side is straight and extends parallel to the y direction. Alternatively, the base side can have a shape that is adapted to the shape of the electric device portion, e.g. be inwardly curved in the shape of a circular segment matching the bent surface of the coil portion. Further, in alternative embodiments the base side can be tapered at least partially, so that e.g. prepreg fibers split by the tool body 10 can be brought in close proximity to the connector 3.

FIGS. 2a to 2c show steps of applying insulating material to an electrical device in accordance with an exemplary embodiment.

As shown in FIGS. 2a to 2c, for illustration the electrical device is a transformer coil 1. Generally, the coil has windings of electrically conductive wires (e.g. copper). The transformer coil 1 includes connectors 3 (here, ends or intermediate portions of the coil wire) protruding from a coil portion of the transformer coil 1.

Prior to the step shown in FIG. 2a, the connectors 3 have already been inserted into the conductor receiving section of the tool body 10. Here, the tool body 10 is the tool body shown in FIGS. 1a to 1c and described above. The connectors 3 are inserted into the slit 26 of the tool body 10 such that a tapered blade edge 12 of the conductor handling tool is directed away from the connector 3 (see also FIG. 1b).

As is shown in FIGS. 2a to 2c, the insulating material is applied onto the coil portion in the form of an insulating tape 5 which is wound onto the coil by turning the coil on a mandrel. Here, the tape 5 is a unidirectional prepreg tape with fibers, e.g. glass fibers, extending along the tape direction, and with a pre-cured solid resin. The insulating material tape or fabric can have a width of between about 5 mm and about 600 mm, for example.

Alternatively or in addition, other insulating material can be provided. For example, also a prepreg in the shape of a tow (tow preg), or an impregnated woven fabric can be used. The insulating material may include dry filaments (dry filament winding), but in some cases also wet filaments (wet filament winding).

During application of the insulating material, a portion thereof (here: of the prepreg tape 5) is split reliably by the blade edge of the tool body 10.

FIG. 2a shows the situation prior to the tape 5 being split. Then, as shown in FIG. 2b, the tape 5 is split and spread along the direction of the fibers such that the fibers slide along the sides of the tool body 10 (one part of the tape 5 on each side of the tool body 10).

Then, as shown in FIG. 2c, the fibers from each side subsequently approach each other after having slid past the tool body 10, due to the tension of the tape 5 and more importantly due to the favorable small lateral extension in x direction of the tool body 10. It is preferred that the tape 5 slides completely past the tool body 10. Then, the tape 5 is able to encapsulate the connector 3 (FIG. 2c) tightly. Therefore, in the final insulating layer that is finally created from the prepreg tape 5, the glass fibers are still under tension and there is almost no resin rich region generated in x direction (sideways) adjacent to the connector 3, and only a little resin rich region in y direction (lengthwise in the direction of the fibers) adjacent to the connector 3.

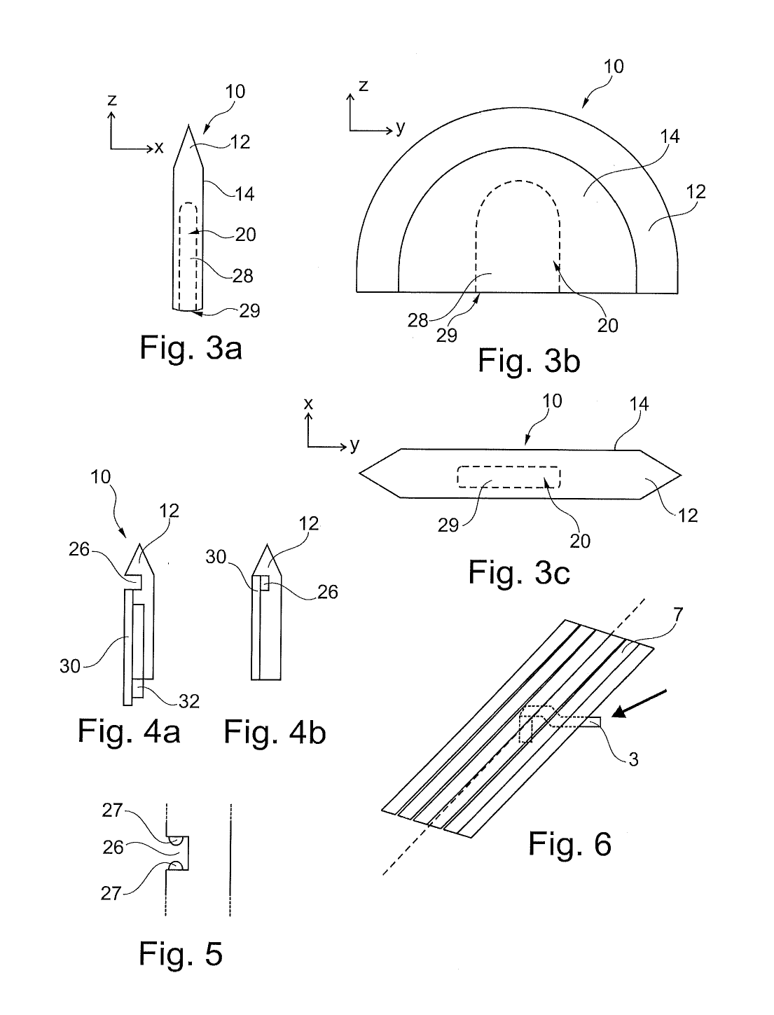

FIGS. 3a to 3c show a second conductor handling tool in respective side views from the y, x, and z direction, respectively in accordance with an exemplary embodiment. FIGS. 3a and 3c correspond to FIGS. 1a to 1c, and same or similar elements are designated by the same reference numbers. In the following, only the differences with respect to the first embodiment (FIGS. 1a to 1c) will be described.

In the exemplary embodiment of FIGS. 3a to 3c, the conductor receiving opening 20 is formed as a slot 28 having one open end 29 (instead of being a slit 26 as in the first embodiment, see FIG. 1b). The conductor receiving opening, or slot 28, is form-fit to the shape of a coil connection flag for receiving the coil connection flag therein. Here, “form-fit” means that the slot 28 is dimensioned such that a main portion of the flag can be inserted therein, and that the slot 28 is adapted to the contour of the flag such that the inserted portion is held therein by the shape of the slot 28. As is seen in FIGS. 3a to 3c, the slot 28 is closed (left and right of the slot 28 in FIG. 3a) by two solid side faces parallel to a z-y plane, so that when the connection flag is inserted from the open end 29, it is stably held by the side faces.

In an exemplary embodiment, the slot 28 can be form-fit to the shape of a coil connection flag having a dimension xx as desired. The slot can have a height in the z direction, for example, between 30 mm and 100 mm, a width in the y direction, for example, between 20 mm and 50 mm, and a depth in the x direction, for example, between 3 mm and 10 mm.

In FIG. 3b, the shape of the tool body 10 and in particular of the blade edge 12 in the y-z plane is shown to be semi-circular. However, while this shape is advantageous, other shapes may be used as well. For example, as a general aspect the shape of the blade in the y-z plane may be adapted to the contour of the conductor receiving opening 20 (i.e. here, to the contour of the slot 28), or have any other shape.

In addition to the above description, the description of the exemplary embodiment of FIGS. 1a to 1c also applies to the exemplary embodiment of FIGS. 3a to 3c.

The conductor handling tool may further include a conductor fixation arrangement adapted to cooperate with the conductor receiving opening for fixating the conductor received in the conductor receiving opening. The conductor fixation arrangement can be e.g. a closing lid, a cover, or a resilient element.

FIGS. 4a and 4b show a third conductor handling tool in a cross-sectional side view from the y direction in accordance with an exemplary embodiment. As shown in FIGS. 4a and 4b the conductor handling tool has a conductor fixation arrangement in a cross-sectional side view from the y direction. This exemplary embodiment is similar to the embodiment of FIGS. 1a to 1c, and same or similar elements are designated by the same reference numbers.

Like in the exemplary embodiment of FIGS. 1a to 1c, the conductor receiving opening is formed as a slit 26 having an open side. In addition, it has, as conductor fixation arrangement, a cover 30 adapted for closing the open side of the slit 26. Here, for closing the open side, the cover 30 has a sliding guide 32 allowing the cover to slide along a surface of the tool body 10 between an open position (with the side of the slit 26 being open, shown in FIG. 4a), and a closed position (with the side of the slit 26 being closed, shown in FIG. 4b). The sliding guide 32 can be e.g. a track fixated at the cover 30 and engaging in a groove at the tool body 10 that allows sliding in the z direction, but fixates the other directions.

The cover 30 has a double advantage. Firstly, when the cover 30 is closed as in FIG. 4b, it serves as a conductor fixation arrangement, because it cooperates with the slit 26 for fixating the conductor received in the slit 26. Secondly, it allows for a smooth outside surface when closed, such as to facilitate sliding of the insulating material past the tool body 10. To this purpose, the cover 30 may include an anti-sticking surface such as PTFE.

Instead of the sliding guide 32, any other fastening means of fastening the cover 30 to the tool body 10 can be provided, such as a hinge connection, a lock, a snap-on connection etc.

FIG. 5 show a detail of a conductor receiving opening in a cross-sectional side view from the y direction in accordance with an exemplary embodiment. In FIG. 5, the conductor receiving opening is a wire receiving slit 26 as in the embodiment of FIGS. 1a to 1c. Further, two resilient elements 27 are provided as conductor fixation arrangement within the wire receiving slit 26. The two resilient elements can be e.g. rubber elements such as rubber tubes extending along the slit 26 or along a portion of the slit 26. Generally, only one resilient element or a plurality of resilient elements may be found suitable for fixating the conductor.

The conductor handling tool can be modified in other ways not described above, without departing from the scope as defined in the patent claims. For example, the conductor receiving opening may be a first conductor receiving opening, namely e.g. a wire receiving slit; and the tool may further include a second conductor receiving opening, e.g. a slot form-fit to the shape of a coil connection flag for receiving the coil connection flag therein. With this design, two conductor receiving openings are provided, the first one being e.g. a slit 26 as described with respect to FIGS. 1a-1c, and the second one being e.g. a slot 28 as described with respect to FIGS. 3a to 3c. Thus, a multi-purpose tool is obtained which is adapted to a plurality of different conductors.

Also, the blade does not need to be provided along the entire upper edge of the tool body 10. Also, a base surface of the tool (i.e. the surface adapted for being in contact with the electrical device) needs not be flat, but can be adapted to the shape of the electrical device. For example, the base surface may be curved inwardly in the case of the electrical device being a wire coil, such as to be adapted to the coil curvature of the wire coil.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method of producing an electrical coil, the electrical coil having a conductor portion, comprising the steps of:
winding a wire to a raw coil;
providing at least one conductor portion protruding from the raw coil, the at least one conductor portion being an electrical connector;
inserting the electrical connector into a conductor receiving section of a conductor handling tool having a curved plate-shaped tool body such that a tapered blade edge of the tool body is directed away from the conductor portion;
winding a tape of an electrically insulating material onto at least a portion of the raw coil;
splitting a portion of the tape by the blade edge; and
removing the conductor handling tool from the conductor portion after splitting.

2. The method according to claim 1, wherein the tape of electrically insulating material has unidirectional fibers, and wherein the tape is applied to the electrical device with the fibers extending in a direction of the blade edge so that the tape is split along a direction of the fibers.

3. A method of producing a transformer, comprising:
producing a first electrical coil by winding a first wire to a first raw coil, providing at least one first conductor portion protruding from the first raw coil, wherein the at least one first conductor portion is a first electrical connector, inserting the first electrical connector into a conductor receiving section of a first conductor handling tool having a curved plate-shaped tool body such that a first tapered blade edge of a first tool body is directed away from the first conductor portion, winding a first tape of a first electrically insulating material onto at least a portion of the first raw coil, splitting a portion of the first tape by the first blade edge, and removing the first conductor handling tool from the first conductor portion after splitting;
producing a second electrical coil by winding a second wire to a second raw coil, providing at least one second conductor portion protruding from the second raw coil, wherein the at least one second conductor portion is a second electrical connector, inserting the second electrical connector into a conductor receiving section of a second conductor handling tool having a curved plate-shaped tool body such that a second tapered blade edge of a second tool body is directed away from the second conductor portion, winding a second tape of a second electrically insulating material onto at least a portion of the second raw coil, splitting a portion of the second tape by the second blade edge, and removing the second conductor handling tool from the second conductor portion after splitting;
providing a transformer housing; and
placing the first electrical coil and the second electrical coil in the transformer housing so that the first electrical coil and the second electrical coil are inductively coupled.

4. A conductor handling tool comprising:
a curved plate-shaped tool body, the tool body comprising:
a conductor receiving opening for receiving a conductor portion and for holding the conductor portion received,
wherein an edge of the plate-shaped tool body is shaped as a tapered blade edge extending within a y-z-plane, and directed away from the conductor receiving opening, and
wherein the tapered blade edge forms an convex outer circumferential portion of the tool body for splitting a portion of insulating material during a winding of the insulating material.

5. The conductor handling tool according to claim 4, wherein the conductor receiving opening extends within a plane that is parallel to the y-z-plane.

6. The conductor handling tool according to claim 4, wherein the tool body has a cross section in a x-y plane, the cross-section having an y:x aspect ratio of at least 2:1.

7. The conductor handling tool according to claim 4, wherein the tool body is integrally made of one piece.

8. The conductor handling tool according to claim 4, wherein the blade edge formed as a circular segment, in particular as a semicircular segment curved in the y-z plane.

9. The conductor handling tool according to claim 4, wherein the conductor receiving opening is formed as a wire receiving slit for receiving the wire sideways therein.

10. The conductor handling tool according to claim 9, wherein the wire receiving slit has a first open end and a second open end for receiving an intermediate wire section there between, the first open end and the second open end being located at a base side of the tool body opposite to the blade edge.

11. The conductor handling tool according to claim 9, wherein the wire receiving slit has a cross-sectional diameter of less than 6 mm.

12. The conductor handling tool according to claim 4, further comprising:
a conductor fixation arrangement for cooperating with the conductor receiving opening for fixating the conductor received in the conductor receiving opening.

13. The conductor handling tool according to claim 4, wherein the conductor receiving opening is form-fit to a shape of a coil connection flag for receiving the coil connection flag therein.

14. The conductor handling tool according to claim 10, wherein the wire receiving slit has a cross-sectional diameter of less than 6 mm.

15. The conductor handling tool according to claim 5, further comprising:
a conductor fixation arrangement for cooperating with the conductor receiving opening for fixating the conductor received in the conductor receiving opening.

16. The conductor handling tool according to claim 6, wherein the conductor receiving opening is form-fit to a shape of a coil connection flag for receiving the coil connection flag therein.

17. The conductor handling tool according to claim 7, further comprising:
a conductor fixation arrangement for cooperating with the conductor receiving opening for fixating the conductor received in the conductor receiving opening.

18. The conductor handling tool according to claim 8, wherein the conductor receiving opening is form-fit to a shape of a coil connection flag for receiving the coil connection flag therein.

19. A method according to claim 1, wherein the conductor handling tool includes:
a curved plate-shaped tool body, the tool body having:
a conductor receiving opening for receiving a conductor portion and for holding the conductor portion received,
wherein an edge of the plate-shaped tool body is shaped as a tapered blade edge extending within a y-z-plane, and directed away from the conductor receiving opening, and
wherein the tapered blade edge forms an convex outer circumferential portion of the tool body for splitting a portion of insulating material during a winding of the insulating material.
